(19) United States
(12) Patent Application Publication
(10) Pub. No.: US 2015/0169235 A1
(43) Pub. Date: Jun. 18, 2015

(54) DATA STORAGE DEVICE AND OPERATING METHOD THEREOF

(71) Applicant: SK hynix Inc., Gyeonggi-do (KR)

(72) Inventor: Won Kyung KANG, Gyeonggi-do (KR)

(73) Assignee: SK hynix Inc., Gyeonggi-do (KR)

(21) Appl. No.: 14/200,312

(22) Filed: Mar. 7, 2014

(30) Foreign Application Priority Data
Dec. 17, 2013 (KR) 10-2013-0156842

(51) Int. Cl. G06F 3/06

(52) U.S. Cl. CPC G06F 3/0619; G06F 3/0688; G06F 3/0634

(57) ABSTRACT

A data storage device includes a memory device and a controller suitable for controlling an operation of the memory device according to a memory interface mode between the memory device and the controller. The controller performs a memory interface matching operation when there is a mismatch between the memory interface modes of the memory device and the controller.

### CROSS-REFERENCES TO RELATED APPLICATION

The present application claims priority under 35 U.S.C. §119(a) to Korean application number 10-2013-0156842, filed on Dec. 17, 2013, in the Korean Intellectual Property Office, which is incorporated herein by reference in its entirety.

### BACKGROUND

1. Technical Field

Various embodiments relate to a data storage device, and more particularly, to a data storage device having a nonvolatile memory device as a storage medium, and an operating method thereof.

2. Related Art

Recently, the paradigm for computing environments has changed to ubiquitous computing so that computer systems can be used anytime and anywhere. Due to this fact, the use of portable electronic devices such as mobile phones, digital cameras, and laptops has rapidly increased. In general, such portable electronic devices use a data storage device having a memory device. The data storage device is used as a main memory device or an auxiliary memory device of the portable electronic device.

The data storage device having a memory device provides advantages in that there are no mechanical moving parts, and thus, stability and durability are excellent, information access speed is high, and power consumption is low. The data storage devices having such advantages include a universal serial bus (USB) memory device, a memory card having various interfaces, and a solid state drive (SSD).

### SUMMARY

A data storage device with improved reliability is described herein.

In an embodiment of the present disclosure, a data storage device may include a memory device and a controller suitable for controlling an operation of the memory device according to a memory interface mode between the memory device and the controller, wherein the controller performs a memory interface matching operation when the memory interface mode mismatches between the memory device and the controller.

In an embodiment of the present disclosure, an operating method of a data storage device may include determining whether a memory interface mode mismatches between a memory device and a controller, and performing a memory interface matching test by trying to communicate with the memory device according to a plurality of supportable memory interface modes when there is a mismatch between the memory interface modes of the memory device and the controller.

According to the embodiments of the present disclosure, the reliability of a data storage device may be improved.

### BRIEF DESCRIPTION OF THE DRAWINGS

Features, aspects, and embodiments are described in conjunction with the attached drawings, in which:

FIG. 1 is a block diagram exemplarily showing a data processing system, which includes a data storage device in accordance with an embodiment of the present disclosure;

FIG. 2 is a flow chart exemplarily showing a memory interface matching operation in accordance with an embodiment of the present disclosure;

FIG. 3 is a flow chart explaining a step of performing a memory interface matching test shown in FIG. 2;

FIG. 4 is a flow chart explaining a step of performing a memory interface matching test shown in FIG. 2;

FIG. 5 is a block diagram exemplarily showing a data processing system in accordance an embodiment of the present disclosure;

FIG. 6 is a block diagram exemplarily showing a solid state drive (SSD) in accordance with an embodiment of the present disclosure;

FIG. 7 is a block diagram exemplarily showing the SSD controller shown in FIG. 6; and

FIG. 8 is a block diagram exemplarily showing a computer system having a data storage device in accordance with an embodiment of the present disclosure.

### DETAILED DESCRIPTION

In the present invention, advantages, features and methods for achieving them will become more apparent after a reading of the following exemplary embodiments taken in conjunction with the drawings. The present invention may, however, be embodied in different forms and should not be construed as being limited to the embodiments set forth herein. Rather, these embodiments are provided to describe the present invention in detail to the extent that a person skilled in the art to which the invention pertains can easily enforce the technical concept of the present invention.

It is to be understood herein that embodiments of the present invention are not limited to the particulars shown in the drawings and that the drawings are not necessarily to scale and in some instances proportions may have been exaggerated in order to more clearly depict certain features of the invention. While particular terminology is used herein, it is to be appreciated that the terminology used herein is for the purpose of describing particular embodiments only and is not intended to limit the scope of the present invention.

As used herein, the term “and/or” includes any and all combinations of one or more of the associated listed items. It will be understood that when an element is referred to as being “on,” “connected to” or “coupled to” another element, it may be directly on, connected or coupled to the other element or intervening elements may be present. As used herein, a singular form is intended to include plural forms as well, unless the context clearly indicates otherwise. It will be further understood that the terms “includes” and/or “including,” when used in this specification, specify the presence of at least one stated feature, step, operation, and/or element, but do not preclude the presence or addition of one or more other features, steps, operations, and/or elements thereof.

Hereinafter, a data storage device and an operating method thereof according to the present disclosure will be described below with reference to the accompanying drawings through exemplary embodiments.

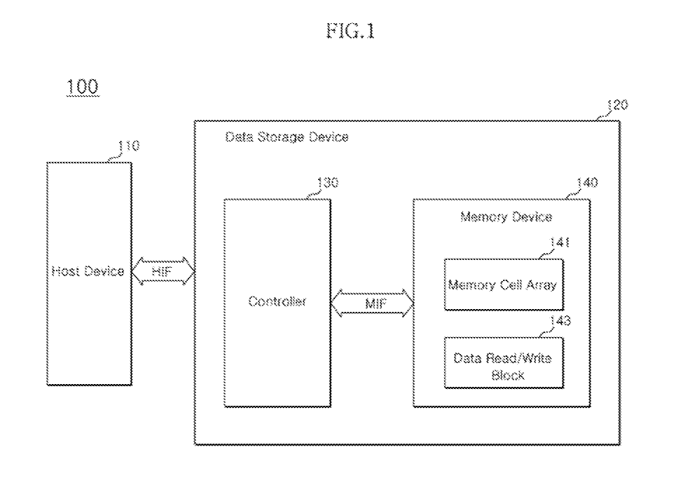

FIG. 1 is a block diagram exemplarily showing a data processing system 100 including a data storage device 120 in accordance with an embodiment of the present disclosure. Referring to FIG. 1, the data processing system 100 may include a host device 110 and a data storage device 120.

The host device 110 may include a portable electronic device such as a mobile phone, an MP3 player, a digital camera and a laptop computer, or an electronic device such as a desktop computer, a game player, a TV and an in-vehicle infotainment system.

The data storage device 120 may operate in response to a request from the host device 110. The data storage device 120 may store data to be accessed by the host device 110. The data storage device 120 may also be referred to as a memory system.

The data storage device 120 may comprise any one of various kinds of storage devices according to the protocol of a host interface HIF electrically coupled with the host device 110. For example, the data storage device 120 may comprise any one of various kinds of storage devices such as a solid state drive (SSD), a multimedia card (MMC), an embedded MMC (eMMC), a reduced size MMC (RS-MMC) and a micro-MMC, a secure digital (SD) card, a mini-SD card and a micro-SD card, a universal serial bus (USB) storage device, a universal flash storage (UFS) device, a Personal Computer Memory Card International Association (PCMCIA) card, a compact flash (CF) card, a smart media card, a memory stick, and so forth.

The data storage device 120 may include a controller 130. The controller 130 may control the general operations of the data storage device 120. The controller 130 may drive firmware or software, which may be loaded on a working memory device (not shown) of the controller 130 in order to control the general operations of the data storage device 120.

The controller 130 may control a memory device 140 in response to a request from the host device 110. For example, the controller 130 may provide data, which is read from the memory device 140, to the host device 110. For another example, the controller 130 may store data, which is provided from the host device 110, in the memory device 140. For these operations the controller 130 may control read, program (or write) and erase operations of the memory device 140.

The controller 130 may set a mode of a memory interface MIF between the controller 130 itself and the memory device 140, through controlling the memory device 140. Further, the controller 130 may control the operations of the memory device 140 according to the set memory interface mode. The memory interface mode may define a command for controlling the memory device 140, a special command, a setting for controlling a function, a control sequence, timing of a control signal, and so forth. For this reason, the memory interface mode may be determined according to the kind of the memory device 140 or an interface mode supported by the memory device 140.

For instance, in the case where the memory device 140 comprises a NAND flash memory device, the memory interface mode may include a single data rate (SDR) mode or a double data rate (DDR) mode, which is defined by the specification of the OPEN NAND FLASH INTERFACE (ONFI). Also, in the case where the memory device 140 comprises a NAND flash memory device, the memory interface mode may include a toggle mode, which is defined by the specification of a specified manufacturer. The toggle mode may mean the DDR mode using a data strobe signal.

The memory device 140 may operate as the storage medium of the data storage device 120. The memory device 140 may comprise any one of various types of nonvolatile memory devices such as a NAND flash memory device, a NOR flash memory device, a ferroelectric random access memory (FRAM) using a ferroelectric capacitor, a magnetic random access memory (MRAM) using a tunneling magneto-resistive (TMR) layer, a phase change random access memory (PCRAM) using chalcogenide alloys, and a resistive random access memory (ReRAM) using a transition metal oxide.

Although a data storage device 120 having one memory device 140 is exemplified in FIG. 1, the data storage device 120 may comprise a plurality of memory devices. In this case, the memory devices included in the data storage device 120 may include a combination of NAND flash memory devices and the various types of nonvolatile memory devices described above.

The memory device 140 may include a memory cell array 141 and a data read/write block 143.

The memory cell array 141 may include memory cells according to the kind of the memory device 140.

The data read/write block 143 may operate as a write driver or a sense amplifier according to the operation mode of the memory device 140. For example, the data read/write block 143 may operate as a sense amplifier for reading the data stored in the memory cells of the memory cell array 141 in the read operation of the memory device 140. For another example, the data read/write block 143 may operate as the write driver for storing the data provided from an external device (for example, the controller 130) in the memory cells of the memory cell array 141 in the write operation of the memory device 140. For instance, the data provided from the external device (for example, the controller 130) may be temporarily stored in latch circuits of the data read/write block 143 before being stored in the memory cells of the memory cell array 141.

In the case where the memory interface mode of the controller 130 and the memory interface mode of the memory device 140 mismatch each other, the data storage device 120 may not operate normally. That is to say, even though the controller 130 tries control over the memory device 140, such control may not be understood by the memory device 140, and thus, the memory device 140 may not respond to the control of the controller 130.

The mismatch state of the memory interface modes between the controller 130 and the memory device 140 may occur when the memory device 140 is initialized. The memory device 140 may be initialized in various cases. For instance, the memory device 140 may be initialized when the data storage device 120 is powered up or booted up. For another instance, the memory device 140 may be initialized when power supply is changed from a normal state to an abnormal state by occurrence of a power drop.

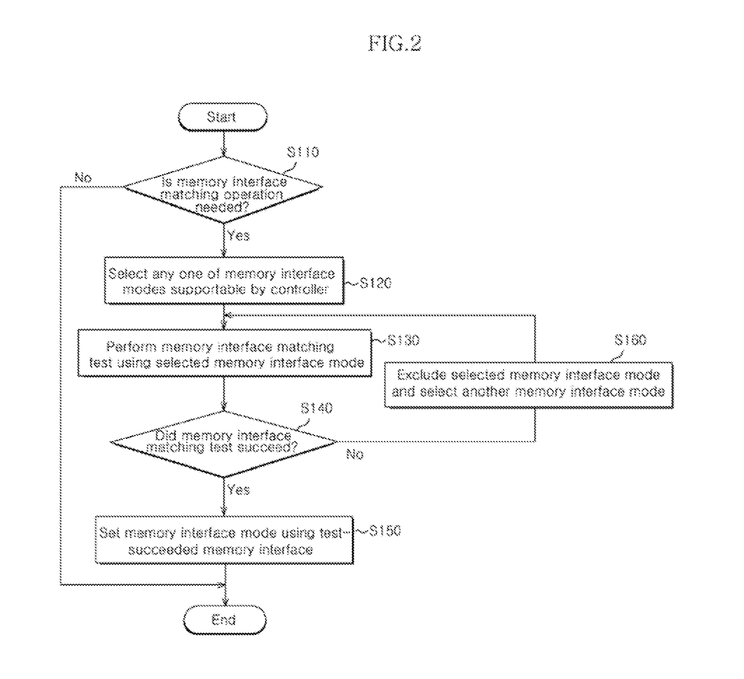

In order to solve the mismatched state of the memory interface modes, the controller 130 may perform a memory interface matching operation. The memory interface matching operation may be performed through a scanning scheme, in which memory interface modes supportable by the controller 130 and memory interface modes supportable by the memory device 140 are sequentially compared one by one. The memory interface matching operation will be described below in detail with reference to FIGS. 2 to 4.

FIG. 2 is a flow chart exemplarily showing the memory interface matching operation in accordance with an embodiment of the present disclosure. With reference to FIGS. 1 and 2, the memory interface matching operation of the data storage device 120 will be described below in detail.

In step S110, the controller 130 may determine whether the memory interface matching operation is needed. For instance, the controller 130 may determine that the memory interface matching operation is needed, or the memory interface mode is in a mismatched state with the memory device 140, when the memory device 140 does not respond to a transmitted control or does not normally operate in response to the transmitted control. As another instance, because the mismatched state of the memory interface mode may occur when the memory device 140 is initialized, the controller 130 may manage the initialization history of the memory device 140 and determine that a memory interface mode is in a mismatched state with the memory device 140 based on the initialization record.

When it is determined that the memory interface mode is in a matched state with the memory device 140, that is, that a memory interface matching operation is not needed, the controller 130 may skip the memory interface matching operation. Conversely, when it is determined that the memory interface mode is in the mismatched state with the memory device 140, that is, that a memory interface matching operation is needed, the controller 130 may perform the memory interface matching operation through following steps S120 to S160.

In step S120, the controller 130 may select any one of supportable memory interface modes.

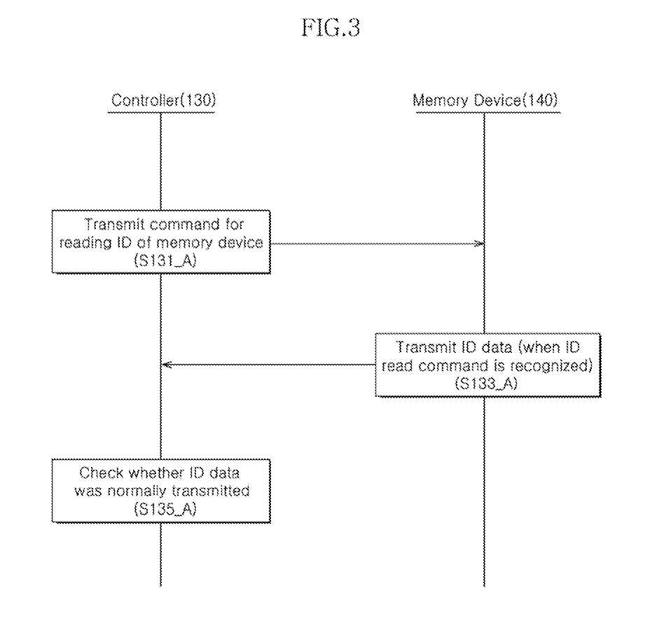

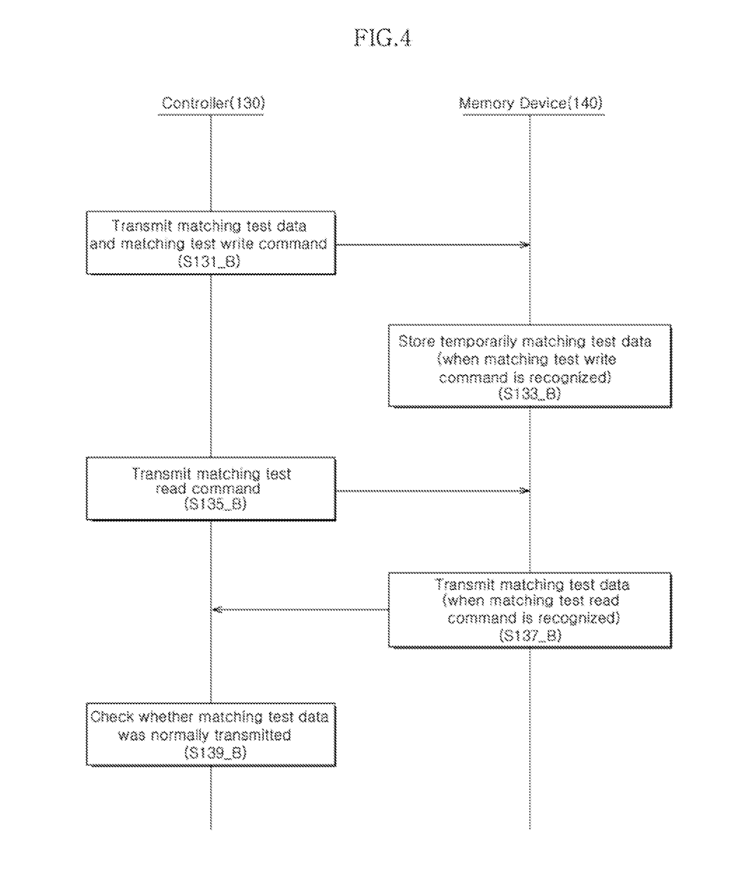

In step S130, the controller 130 may perform a memory interface matching test operation with the memory interface mode selected at step S120. During the memory interface matching test operation at step S130, it is tested whether or not the memory device 140 correctly responds to a test control transmitted by the controller 130. The memory interface matching test operation of step 130 will be described later in detail with reference to FIGS. 3 and 4.

In step S140, the controller 130 may determine the success of the memory interface matching test of the step 130. In the case where the memory interface matching test of the step 130 is a success, it is not necessary to perform the memory interface matching test again and the process will proceed to the step S150. Conversely, when the memory interface matching test operation has failed it is necessary to perform the memory interface matching test with another memory interface mode and the process will proceed to the step S160.

In step S150, the controller 130 may set its memory interface mode by the memory interface with which the memory interface matching test operation of the step S130 has succeeded.

In step S160, the controller 130 may select another memory interface mode other than the memory interface with which the memory interface matching test operation of step S130 has failed. That is to say, the controller 130 may exclude the memory interface mode with which the memory interface matching test operation of the step S130 has failed and may select one of the other memory interface modes. Then, steps S130, S140 and S160 may be repeated until the memory interface matching test of step S130 succeeds.

FIG. 3 is a flow chart explaining in detail the step S130 of performing the memory interface matching test shown in FIG. 2. With reference to FIGS. 1 and 3, the memory interface matching test performing step S130 shown in FIG. 2 will be described below in detail.

In step S131_A, the controller 130 may transmit an ID read command for outputting identification data, that is, an ID of the memory device 140 to the memory device 140. The ID read command may be transmitted according to the memory interface mode selected at step S120 or S160. In other words, the ID read command may be transmitted in conformity with the ID read command codes, the control sequence and the timing of control signals of the memory interface mode selected at step S120 or S160.

In step S133_A, the memory device 140 may transmit ID data when the ID read command is recognized by the memory device 140. If the memory interface mode of the memory device 140 does not match with the memory interface mode selected at the step S120 or S160, the memory device 140 may not respond to the ID read command or may not transmit a response appropriate to the ID read command.

In step S135_A, the controller 130 may determine whether or not the ID data is correctly transmitted. For instance, in the case where the memory device 140 has correctly transmitted the ID data, the controller 130 may determine that the memory interface matching test has succeeded. In this case, the result of step S140 of FIG. 2 may be determined as success and the process of the memory interface matching operation shown in FIG. 2 may move to step S150. For another instance, in the case where the memory device 140 has not correctly transmitted the ID data or does not respond to the ID read command, the controller 130 may determine that the memory interface matching test has failed. In this case, the result of step S140 of FIG. 2 may be determined as a failure and the process of the memory interface matching operation shown in FIG. 2 may move to step S160.

FIG. 4 is a flow chart explaining in detail the step S130 of performing the memory interface matching test shown in FIG. 2. With reference to FIGS. 1 and 4, the memory interface matching test performing step S130 shown in FIG. 2 will be described below in detail.

In step S131_B, the controller may transmit to the memory device 140 matching test data for the interface matching test and a matching test write command for storing the matching test data in the memory device 140. The matching test write command may control the matching test data to be temporarily stored in the data read/write block 143 of the memory device 140 and not to be stored in the memory cell array 141.

The matching test write command may be transmitted according to the memory interface mode selected at the step S120 or S160. Namely, the matching test write command may be transmitted in conformity with the write command codes, the control sequence and the timing of control signals of the memory interface mode selected at step S120 or S160.

In step S133_B, the memory device 140 may store the matching test data in the data read/write block 143 when the matching test write command is recognized by the memory device 140. As the matching test data is stored in only the data read/write block 143 according to the matching test write command, it is possible to prevent data change in the memory cell array 141. If the memory interface mode of the memory device 140 does not match with the memory interface mode selected at step S120 or S160, the memory device 140 may not respond to the matching test write command or may not perform a write operation appropriate to the matching test write command.

In step S135_B, the controller 130 may transmit to the memory device 140 a matching test read command for reading out the matching test data stored in the data read/write block 143. The matching test read command may control the matching test data stored in the data read/write block 143 to be read out.

The matching test read command may be transmitted according to the memory interface mode selected at step S120 or S160. That is to say, the matching test read command may be transmitted in conformity with the test read command codes, the control sequence and the timing of control signals of the memory Interface mode selected at step S120 or S160.

In step S137_B, the memory device 140 may transmit the matching test data to the controller 130 when the matching test read command is recognized by the memory device 140. If the memory interface mode of the memory device 140 does not match with the memory interface mode selected at step S120 or S160, the memory device 140 may not respond to the matching test read command or may not transmit a response appropriate to the matching test read command.

In step S139_B, the controller 130 may determine whether or not the matching test data is correctly transmitted. For example, the controller 130 may compare the sent matching test data transmitted with the matching test write command and the received matching test data from the memory device 140. The controller 130 may determine whether or not the received matching test data has been correctly transmitted, according to a result of comparing the sent matching test data and the received matching test data.

For instance, the controller 130 may determine that the memory interface matching test has succeeded, when the sent matching test data and the received matching test data are the same. In this case, the result of the step S140 of FIG. 2 may be determined a success and the process of the memory interface matching operation shown in FIG. 2 may move to the step S150. For another instance, in the case where the sent matching test data and the received matching test data are different from each other or the memory device 140 does not respond to any command sent from the controller 130, the controller 130 may determine that the memory interface matching test has failed. In this case, the result of the step S140 of FIG. 2 may be determined as a fail and the process of the memory interface matching operation shown in FIG. 2 may move to step S160.

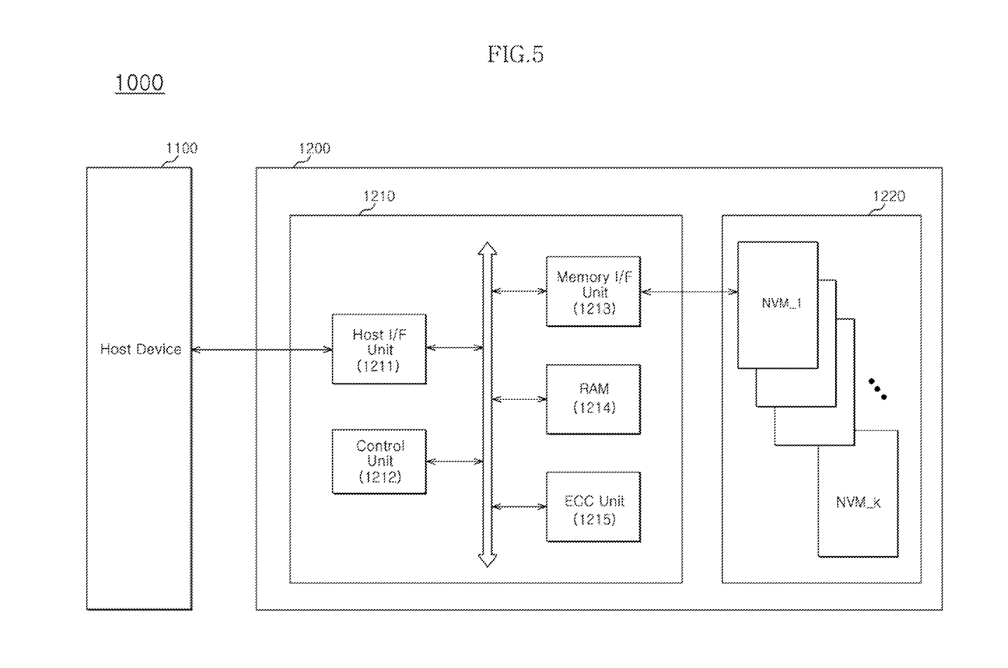

FIG. 5 is a block diagram exemplarily showing a data processing system in accordance an embodiment of the present disclosure. Referring to FIG. 5, a data processing system 1000 may include a host device 1100 and a data storage device 1200.

The data storage device 1200 may include a controller 1210, and a nonvolatile memory device 1220. The data storage device 1200 may be used by being electrically coupled to the host device 1100 such as a desktop computer, a notebook computer, a digital camera, a mobile phone, an MP3 player, a game player, and so forth. The data storage device 1200 is also referred to as a memory system.

The controller 1210 may access the nonvolatile memory device 1220 in response to a request from the host device 1100. For example, the controller 1210 may control the read, program or erase operation of the nonvolatile memory device 1220. The controller 1210 may drive firmware for controlling the nonvolatile memory device 1220.

The controller 1210 may set a memory interface mode between the controller 1210 itself and the nonvolatile memory device 1220, through controlling the nonvolatile memory device 1220. The controller 1210 may perform a memory interface matching operation in accordance with the embodiment of the present disclosure when the memory interface mode of the controller 1210 itself and the memory interface mode set in the nonvolatile memory device 1220 mismatch each other.

The controller 1210 may include well-known component elements such as a host interface unit 1211, a control unit 1212, a memory interface unit 1213, a RAM 1214 and an error correction code (ECC) unit 1215.

The control unit 1212 may control the general operations of the controller 1210 in response to a request from the host device 1100. The RAM 1214 may be used as the working memory of the control unit 1212. The RAM 1214 may temporarily store the data read from the nonvolatile memory device 1220 or the data provided from the host device 1100.

The host interface unit 1211 may interface the host device 1100 and the controller 1210. For example, the host interface unit 1211 may communicate with the host device 1100 through one of various interface protocols such as a universal flash storage (UFS) protocol, a universal serial bus (USB) protocol, a multimedia card (MMC) protocol, a peripheral component interconnection (PCI) protocol, a PCI express (PCI-E) protocol, a parallel advanced technology attachment (PATA) protocol, a serial advanced technology attachment (SATA) protocol, a small computer system interface (SCSI) protocol, and a serial attached SCSI (SAS) protocol.

The memory interface unit 1213 may interface the controller 1210 and the nonvolatile memory device 1220. The memory interface unit 1213 may provide commands, addresses and control signals to the nonvolatile memory device 1220. Furthermore, the memory interface unit 1213 may exchange data with the nonvolatile memory device 1220.

The error correction code unit 1215 may detect an error of the data read from the nonvolatile memory device 1220. Also, the error correction code unit 1215 may correct the detected error when the detected error falls within a correctable range. Meanwhile, the error correction code unit 1215 may be provided inside or outside the controller 1210 according to the memory system 1000.

The nonvolatile memory device 1220 may be used as the storage medium of the data storage device 1200. The nonvolatile memory device 1220 may be constituted by one or more nonvolatile memory devices NVM_1 to NVM_k according to the storage capacity of the data storage device 1200.

The controller 1210 and the nonvolatile memory device 1220 may be integrated into one semiconductor apparatus and may be configured as a memory device. For example, the controller 1210 and the nonvolatile memory device 1220 may be integrated into one semiconductor apparatus and may be configured as a multimedia card in the form of an MMC, an eMMC, an RS-MMC and a micro-MMC, a secure digital card in the form of an SD, a mini-SD and an micro-SD, a universal serial bus (USB) storage device, a universal flash storage (UFS) device, a Personal Computer Memory Card International Association (PCMCIA) card, a compact flash (CF) card, a smart media card, a memory stick, and so forth.

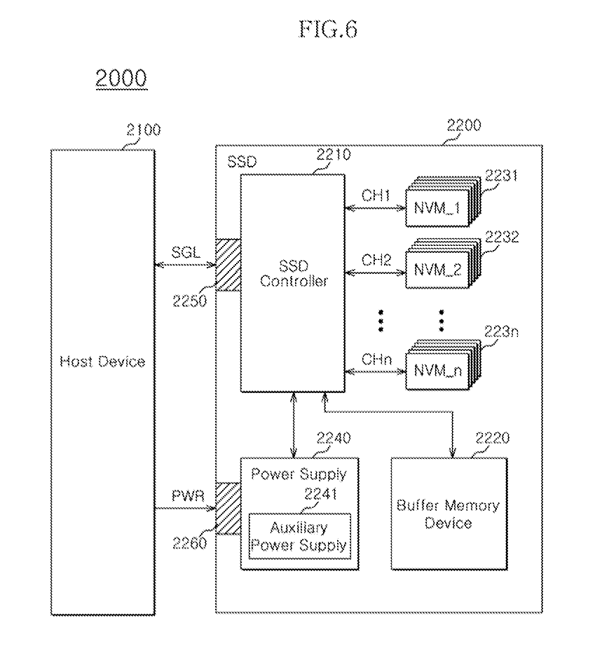

FIG. 6 is a block diagram exemplarily showing a solid state drive (SSD) in accordance with an embodiment of the present disclosure. Referring to FIG. 6, a data processing system 2000 may include a host device 2100 and a solid state drive (SSD) 2200.

The SSD 2200 may include an SSD controller 2210, a buffer memory device 2220, nonvolatile memory devices 2231 to 223n, a power supply 2240, a signal connector 2250, and a power connector 2260.

The SSD 2200 may operate in response to a request from the host device 2100. That is to say, the SSD controller 2210 may access the nonvolatile memory devices 2231 to 223n in response to a request from the host device 2100. For example, the SSD controller 2210 may control the read, program and erase operations of the nonvolatile memory devices 2231 to 223n.

The SSD controller 2210 may set a memory interface mode between the SSD controller 2210 itself and the nonvolatile memory devices 2231 to 223n, through controlling the nonvolatile memory devices 2231 to 223n. The SSD controller 2210 may perform a memory interface matching operation in accordance with the embodiment of the present disclosure when the memory interface mode of the SSD controller 2210 itself and the memory interface mode set in the nonvolatile memory devices 2231 to 223n mismatch each other.

The buffer memory device 2220 may temporarily store data in the nonvolatile memory devices 2231 to 223n. Further, the buffer memory device 2220 may temporarily store data, which is read from the nonvolatile memory devices 2231 to 223n. The data temporarily stored in the buffer memory device 2220 may be transmitted to the host device 2100 or the nonvolatile memory devices 2231 to 223n under the control of the SSD controller 2210.

The nonvolatile memory devices 2231 to 223n may be used as storage media of the SSD 2200. The nonvolatile memory devices 2231 to 223n may be electrically coupled to the SSD controller 2210 through a plurality of channels CH1 to CHn, respectively. One or more nonvolatile memory devices may be electrically coupled to one channel. The nonvolatile memory devices electrically coupled to one channel may be electrically coupled to the same signal bus and data bus.

The power supply 2240 may provide power PWR inputted through the power connector 2260, to the inside of the SSD 2200. The power supply 2240 may include an auxiliary power supply 2241. The auxiliary power supply 2241 supply power so as to allow the SSD 2200 to be normally terminated when a sudden power-off occurs. The auxiliary power supply 2241 may include super capacitors capable of being charged with power PWR.

The SSD controller 2210 may exchange a signal SGL with the host device 2100 through the signal connector 2250. The signal SGL may include a command, an address, data, and so forth. The signal connector 2250 may be constituted by a connector such as a parallel advanced technology attachment (PATA), serial advanced technology attachment (SATA), small computer system interface (SCSI), serial attached SCSI (SAS), peripheral component interconnection (PCI) and PCI express (PCI-E) protocols, according to the interface scheme between the host device 2100 and the SSD 2200.

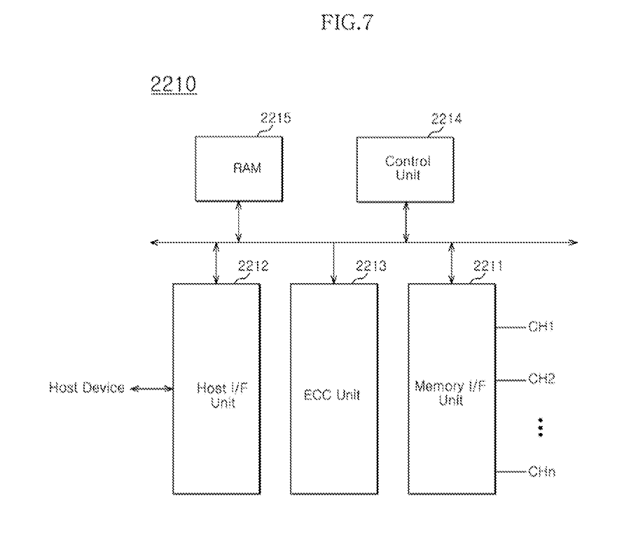

FIG. 7 is a block diagram exemplarily showing the SSD controller shown in FIG. 6. Referring to FIG. 7, the SSD controller 2210 includes a memory interface unit 2211, a host interface unit 2212, an error correction code (ECC) unit 2213, a control unit 2214, and a RAM 2215.

The memory interface unit 2211 may provide a command and an address to the nonvolatile memory devices 2231 to 223n. Moreover, the memory interface unit 2211 may exchange data with the nonvolatile memory devices 2231 to 223n. The memory interface unit 2211 may scatter the data transmitted from the buffer memory device 2220 to the respective channels CH1 to CHn, under the control of the control unit 2214. Furthermore, the memory interface unit 2211 may transfer the data read from the nonvolatile memory devices 2231 to 223n to the buffer memory device 2220, under the control of the control unit 2214.

The host interface unit 2212 may provide an interface with the SSD 2200 in correspondence to the protocol of the host device 2100. For example, the host Interface unit 2212 may communicate with the host device 2100 through one of parallel advanced technology attachment (PATA), serial advanced technology attachment (SATA), small computer system interface (SCSI), serial attached SCSI (SAS), peripheral component interconnection (PCI) and PCI express (PCI-E) protocols. In addition, the host interface unit 2212 may perform a disk emulating function of supporting the host device 2100 to recognize the SSD 2200 as a hard disk drive (HDD).

The ECC unit 2213 may generate parity bits based on the data transmitted to the nonvolatile memory devices 2231 to 223n. The generated parity bits may be stored in spare areas of the nonvolatile memory devices 2231 to 223n. The ECC unit 2213 may detect an error of the data read from the nonvolatile memory devices 2231 to 223n. When the detected error falls within a correctable range, the ECC unit 2213 may correct the detected error.

The control unit 2214 may analyze and process a signal SGL inputted from the host device 2100. The control unit 2214 may control the general operations of the SSD controller 2210 in response to a request from the host device 2100. The control unit 2214 may control the operations of the buffer memory device 2220 and the nonvolatile memory devices 2231 to 223n according to the firmware for driving the SSD 2200. The RAM 2215 may be used as a working memory device for driving the firmware.

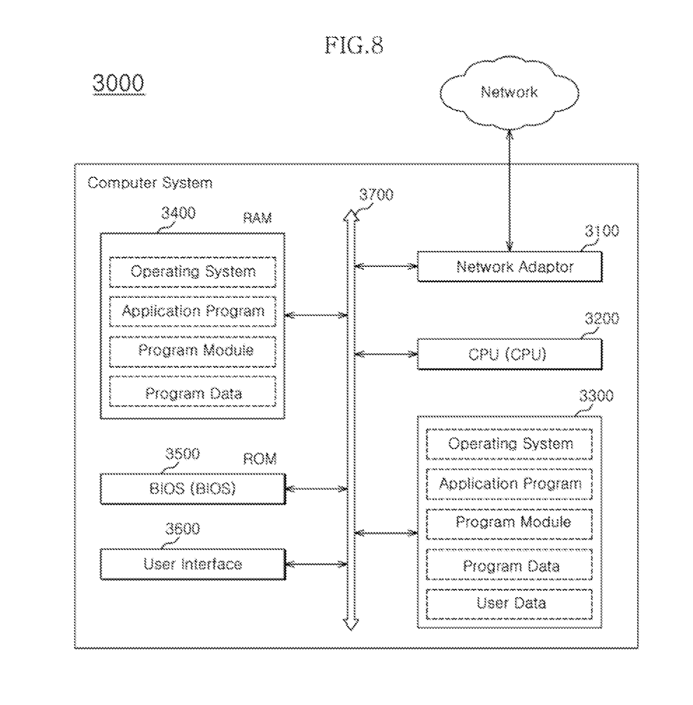

FIG. 8 is a block diagram exemplarily showing a computer system having the data storage device in accordance with an embodiment of the present disclosure. Referring to FIG. 8, a computer system 3000 includes a network adaptor 3100, a central processing unit 3200, a data storage device 3300, a RAM 3400, a ROM 3500 and a user interface 3600, which are electrically coupled to a system bus 3700. The data storage device 3300 may be constituted by the data storage device 120 shown in FIG. 1, the data storage device 1200 shown in FIG. 5 or the SSD 2200 shown in FIG. 6.

The network adaptor 3100 provides interfacing between the computer system 3000 and external networks. The central processing unit 3200 performs general operations for driving an operating system residing at the RAM 3400 or an application program.

The data storage device 3300 stores general data necessary in the computer system 3000. For example, an operating system for driving the computer system 3000, an application program, various program modules, program data and user data are stored in the data storage device 3300.

The RAM 3400 may be used as a working memory device of the computer system 3000. Upon booting, the operating system, the application program, the various program modules and the program data necessary for driving programs, which are read from the data storage device 3300, are loaded on the RAM 3400. A BIOS (basic input/output system) which is activated before the operating system is driven is stored in the ROM 3500. Information exchange between the computer system 3000 and a user is implemented through the user interface 3600.

Although not shown in a drawing, it is to be readily understood that the computer system 3000 may further include devices such as an application chipset, a camera image processor, and so forth.

While certain embodiments have been described above, it will be understood to those skilled in the art that the embodiments described are by way of example only. Accordingly, the data storage device and the operating method thereof described herein should not be limited based on the described embodiments. Rather, the data storage device and the operating method thereof described herein should only be limited in light of the claims that follow when taken in conjunction with the above description and accompanying drawings.

What is claimed is:

1. A data storage device comprising:
a memory device; and
a controller suitable for controlling an operation of the memory device according to a memory interface mode between the memory device and the controller,
wherein the controller performs a memory interface matching operation when the memory interface mode mismatches between the memory device and the controller.

2. The data storage device according to claim 1, wherein the controller performs the memory interface matching operation by trying to communicate with the memory device using a plurality of supportable memory interface modes.

3. The data storage device according to claim 2, wherein the controller performs a memory interface matching test using a supportable memory interface mode selected from the plurality of supportable memory interface modes.

4. The data storage device according to claim 3, wherein the controller sets the memory interface mode between the memory device and the controller according to a result of the memory interface matching test.

5. The data storage device according to claim 3, wherein the controller repeats the memory interface matching test with another supportable memory interface mode from the plurality of supportable memory interface modes when a previously selected memory interface matching test has failed.

6. The data storage device according to claim 5, wherein the controller selects a different supportable memory interface mode from the plurality of supportable memory interface modes by excluding a previously selected supportable memory interface mode, with which the memory interface matching test has failed, from the plurality of supportable memory interface modes and repeating the memory interface matching test with the different supportable memory interface mode.

7. The data storage device according to claim 3, wherein the controller transmits an ID read command during the memory interface matching test for reading an ID data of the memory device and verifies whether the ID data has correctly transmitted from the memory device.

8. The data storage device according to claim 3, wherein during the memory interface matching test the controller sends to the memory device a matching test data and a matching test write command to store the matching test data in the memory device, and verifies whether the sent matching test data has been correctly transmitted back from the memory device.

9. The data storage device according to claim 8, wherein the controller verifies whether the sent matching test data has been correctly transmitted back from the memory device by comparing the sent matching test data and a received matching test data transmitted back from the memory device according to a matching test data read command.

10. The data storage device according to claim 8, wherein the memory device temporarily stores the sent matching test data in a data read/write block in response to the matching test write command.

11. The data storage device according to claim 10, wherein the memory device transmits back to the controller the sent matching test data temporarily stored in the data read/write block in response to the matching test data read command.

12. The data storage device according to claim 2, wherein the memory device comprises a nonvolatile memory device.

13. The data storage device according to claim 12, wherein the plurality of supportable memory interface modes include a single data rate mode, a double data rate mode and a toggle mode.

14. An operating method of a data storage device, comprising:
determining whether a memory interface mode mismatches between a memory device and a controller; and
performing a memory interface matching test by trying to communicate with the memory device according to a plurality of supportable memory interface modes when there is a mismatch between the memory interface modes of the memory device and the controller.

15. The method according to claim 14, wherein the determining comprises one or more of determining whether the memory device responds to a control of the controller, determining whether the memory device correctly operates in response to the control of the controller, and determining whether the memory device is initialized.

16. The method according to claim 14, further comprising setting the memory interface mode between the memory device and the controller according to result of the memory interface matching test.

17. The method according to claim 14, further comprising repeating the memory interface matching test with a different supportable memory interface mode, from the plurality of supportable memory interface modes, when the memory interface matching test with a previously selected supportable memory interface mode has failed.

18. The method according to claim 14, wherein the performing of the memory interface matching test comprises checking whether a read operation of ID data of the memory device, in response to an ID read command from the controller, is correctly performed.

19. The method according to claim 14, wherein the performing of the memory interface matching test comprises checking whether data transmitted from the memory device is identical to data transmitted from the controller to the memory device.

20. The method according to claim 14, wherein the plurality of supportable memory interface modes include a single data rate mode, a double data rate mode and a toggle mode.
